(19) United States
(12) Patent Application Publication
(10) Pub. No.: US 2006/0251767 A1
(43) Pub. Date: Nov. 9, 2006

(54) Packaged food product

(76) Inventor: John Blackwell, Gary, IN (US)

Correspondence Address: Michael H. Baniak;Andrew F. Pratt, BANIAK PINE & GANNON, 150 N. Wacker Drive, Suite 1200, Chicago, IL, 60201, US

(21) Appl. No.: 11/194,101

(22) Filed: Jul. 29, 2005

Related U.S. Application Data
(60) Provisional application No. 60/677,984, filed on May 5, 2005.

(51) Int. Cl. A23G 3/00

(52) U.S. Cl. 426/90

(57) ABSTRACT

Assemblies of packaged food items that maintain the orientations of food items within the package relative to each other are provided. Assemblies that include rectilinear edible packaging having tabs formed on the packaging are also provided. Also provided are methods for manufacturing a packaged food items that maintain the orientations of food items within the package relative to each other.

This application claims the benefit of U.S. Provisional Patent Application Ser. No. 60/677,984 filed May 5, 2005.

### FIELD OF THE INVENTION

The subject invention relates to food products packaged in edible packaging. Embodiments of the subject invention also relate to methods for manufacturing a packaged food item.

### BACKGROUND OF THE INVENTION

Pre-made and prepared foods are common. Often times, such foods are available in grocery stores as pre-made, frozen or refrigerated food items that may be cooked by the end user. Other examples are prepared food items available from restaurants and kiosks. Among such pre-made and prepared food items are ones that include edible outer packaging that holds various food items within them, but in no particular orientation as between particular food items within the outer packaging.

Use of such packaged food items works well with foods such that utilize a mix of food items to be packaged, which are typically consist of several distinct food items that are diced or pureed, and subsequently blended to achieve an overall regular consistency and distribution of flavors. However, such assemblies are not without problems. In some instances, consumers will desire to have certain types of prepared food items having a regular consistency and flavor throughout the assembly, but desire to not have the starting components obliterated and mixed with the other components such that the original textures of the starting components would be no longer identifiable. Problems arise when attempting to manufacture a packaged food assembly that contains food items having different consistencies that are intended to be evenly distributed throughout the assembly. Too much of one particular food item can concentrate in one area of the assembly, which results in an overall imbalance in the distribution of the constituent parts of the assembly.

Other problems in flavor distribution and materials costs occurs when using a food packaging having an overall square or rectangular shape to manufacture a cylindrical food package. In such instances, the package is often created by rolling the food within the edible packaging material diagonally between opposite corners and folding the other corners in to create the ends. The resulting assembly will have an uneven distribution of edible packaging material along the length of the food package, which alters the flavor ratios along the length of the assembly. In addition, such an assembly tends to require more edible packaging material than necessary, which increases the overall cost of the assembly.

There is a demand, therefore, for a food assembly of food items having different consistencies that controls flavor ratios within the assembly. There is also a need for a food assembly that employs an edible packaging material that promotes more regular flavor ratios within the assembly, and that also requires less edible packaging material to manufacture the assembly. The present invention satisfies these demands.

### SUMMARY OF THE INVENTION

It is a principal objective of the present invention to provide an assembly of food items in packaged form, with the constituent parts of the assembly having predictable proportions relative to each other. Embodiments of the invention disclose a packaged food item that includes an encapsulated food product of predetermined size and shape; an edible wrapper enveloping the encapsulated food product, the edible wrapper having a predetermined size and shape sufficient to completely surround the encapsulated food product, the edible wrapper having a substantially uniform thickness, the edible wrapper shape being rectilinear, the rectilinear shape including at least one set of opposed peripheral edges, and wherein at least a portion of the edible wrapper is spaced apart from the encapsulated food product to define a space between the edible wrapper and the encapsulated food product; and a viscous food product disposed within the space, the edible wrapper and the encapsulated food product each providing a surface to associate with the viscous food product whereby the migration of the viscous food product within the space is inhibited. Other embodiments of the packaged food item include a pair of tabs formed on the at least one set of opposed peripheral edges of the edible wrapper. In another embodiment of the packaged food item, the encapsulated food product is a meat product packaged within a casing. In still another embodiment of the packaged food item, the encapsulated food product has a longitudinal length; the space defined by the edible wrapper and the encapsulated food product substantially surrounds the encapsulated food product; and a predetermined amount of viscous food product is disposed within the space substantially surrounding the encapsulated food product such that the distribution of the viscous food product along the longitudinal length of the encapsulated food product is substantially uniform.

In still other embodiments, the edible wrapper of the packaged food item that envelopes the encapsulated food product is comprised of a plurality of edible wrappers, each edible wrapper having a predetermined size and shape, the plurality of edible wrappers in combination being sufficient to completely surround the encapsulated food product, the plurality of edible wrappers each having a substantially uniform thickness, the shape of the plurality of edible wrappers being rectilinear, the rectilinear shape of each edible wrapper including at least one set of opposed peripheral edges, and wherein at least a portion of at least one edible wrapper of the plurality of edible wrappers is spaced apart from the encapsulated food product to define a space between the edible wrapper and the encapsulated food product. In another embodiment, the encapsulated food product of this packaged food item has a longitudinal length; a portion of each of the plurality of edible wrappers is spaced apart from the edible food product to define at least one space between the plurality of edible wrappers and the encapsulated food product, the at least one space substantially surrounding the encapsulated food product; and a predetermined amount of viscous food product is disposed within the at least one space such that the distribution of the viscous food product along the longitudinal length of the encapsulated food product is substantially uniform.

Other embodiments of packaged food items are disclosed that include an encapsulated food product, the encapsulated food product consisting essentially of a meat product packaged within a casing, the encapsulated food product having a first end and an opposed second end; an edible wrapper enveloping the encapsulated food product, the edible wrapper having a predetermined size and shape sufficient to completely surround the encapsulated food product, the edible wrapper shape being rectilinear, the rectilinear shape including at least one set of opposed peripheral edges; and a first tab and a second tab formed on the at least one set of opposed peripheral edges, the first tab being positioned proximate the first end of the encapsulated meat product, the second tab being positioned proximate the second end of the encapsulated meat product, the first tab and the second tab being adapted to be positioned over the first end and the second end of the encapsulated food product whereby the first tab forms a first end of the packaged food item and the second tab forms the second end of the packaged food item. Additional embodiments of the packaged food item have at least a portion of the edible wrapper spaced apart from the encapsulated food product to define a space between the edible wrapper and the encapsulated food product. In other embodiments, a viscous food product disposed within the space, and the edible wrapper and the encapsulated food product each provide a surface to associate with the viscous food product whereby the migration of the viscous food product within the space is inhibited. And in still other embodiments, the amount of viscous food product disposed within the space is predetermined.

Another object of the present invention is to provide a method for manufacturing a packaged food item. The method can include providing a sheet of edible material having a predetermined size and shape, the sheet of edible material including a first surface and a second surface, the first surface and second surface being substantially planar, the sheet of edible material having a substantially uniform thickness and a rectilinear border, the rectilinear border including opposed regions, the sheet of edible material being adapted to surround and envelop a food item emplaced proximate the first surface; providing an encapsulated food product proximate the first surface of the edible material, the encapsulated food product consisting essentially of a meat product packaged within a casing, the encapsulated food product having a predetermined size; distributing a predetermined amount of viscous food product over at least a portion of the packaged food product; and enveloping the encapsulated food product and the viscous food product with the sheet of edible material such that the packaged food item and the viscous food product are completely surrounded by the sheet of edible material, the sheet of edible material and encapsulated food product each providing a surface to associate with the viscous food product whereby the edible wrapper and the encapsulated food product inhibit the migration of the viscous relative to the edible wrapper and the encapsulated food product.

Embodiments of the packaging provide food manufacturers with the ability to achieve the maintenance of the relative orientations of the constituent parts of the assembly by providing a close association between the various parts of the assembly that would otherwise be difficult to associate due to viscosity of certain constituent parts, and by preventing substantial movement or pooling of the viscous food product within the space between the encapsulated food product and the edible wrapper. Such maintenance of relative orientation and proportion also serves to regulate flavor ratios at most cross-sectional points of the assembly, as well as promote more even temperature distribution throughout the assembly during cooking. In addition, certain embodiments further promote more constant flavor ratios by the addition of tabs on the edible wrapper to form ends of the assembly, thereby allowing the mid section of the assembly to have a fairly constant amount of edible wrapper material present in any particular cross-sectional sampling, excluding the cross-sections corresponding to the regions proximate the ends.

These and other features and advantages of the present invention will be further understood and appreciated when considered in relation to the following detailed description of embodiments of the invention, taken in conjunction with the drawings, in which:

### BRIEF DESCRIPTION OF THE DRAWINGS

FIG. 1 illustrates a plan view of one embodiment of a packaged food item assembly;

FIG. 2A illustrates an elevation view of another embodiment of a packaged food item assembly;

FIG. 2B illustrates a cross-sectional view of another embodiment of a packaged food item assembly;

FIG. 3 illustrates yet another embodiment of a packaged food item assembly.

### DETAILED DESCRIPTION OF A PRESENTLY PREFERRED EMBODIMENT

The present invention relates generally to packaged food items and methods for manufacturing packaged food items. Embodiments of the present invention will find general application in the market for prepared foods, including frozen pre-manufactured foods and so-called fast food, typically sold in restaurants or at stands.

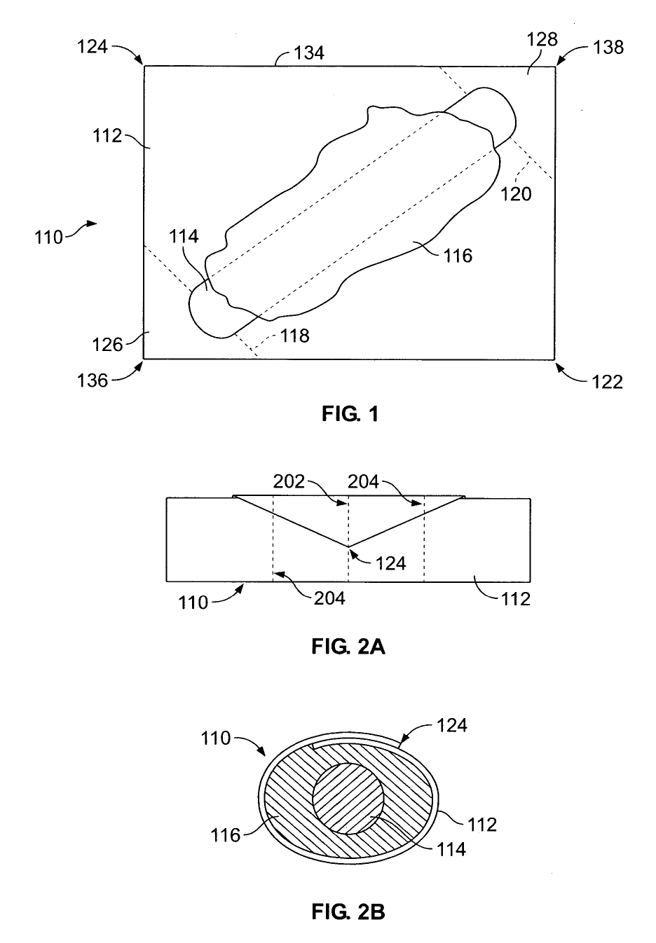

It is a principal objective of the present invention to provide an assembly of foods packaged in an edible packaging. As shown in FIGS. 1 and 2, embodiments of the present invention provide packaging 112 to hold together food items 114, 116 in a particular orientation with respect to one another that would otherwise be difficult to achieve and maintain, and to keep the food items 114, 116 associated through shipment, cooking, and subsequent delivery to the customer. One example of the assembly includes a sheet of edible packaging in the form of an edible wrapper 112 in association with an encapsulated food product 114 and a viscous food product 116. In a preferred embodiment, the edible packaging 112 can be, for example, any of a variety of commercially-available egg-roll type wrappers, which are relatively resilient and resist tearing during assembly. Such wrappers 112 typically have a peripheral edge 134 defining a square or rectangular configuration with two planar sides. In addition, the egg-roll type wrapper cooks quickly relative to other types of wrapper, such as flour-based pastry dough and the like, which are nevertheless suitable for use in connection with embodiments of the invention. Such edible wrappers further exhibit a high degree of regularity in thickness, which promotes more even flavor distribution over the length of the assembly 110, and further are relatively thin and resilient as compared to leavened breads, which tend to be undesirably bulky and deformable. Examples of encapsulated food product 114 are any foods that are packaged within an edible, typically membranous, capsule or casing, such as sausages and the like; the encapsulated food product 114 may also include skinless sausages. Within a particular product line, such encapsulated food products 114 are often machine-made and display a high degree of regularity in size and shape, as are the size and shape of commercially-available edible wrappers 112. This predictability aids food manufacturers in controlling costs associated with manufacturing the packaged food items, as it allows manufacturers to use a particular size of edible wrapper 112 in conjunction with a corresponding size of encapsulated food product 114. Use of predetermined sizes of both edible wrapper 112 and encapsulated food product 114 further eliminates the additional step of tailoring the size of the edible wrapper 122 or encapsulated food product 122, or adjusting the amount of viscous food product 116 provided due to non-uniformity of the assembly's 110 components. As such, this predictability in size further allows for a relatively constant rate of manufacture without the need to make appropriate size selections of edible wrapper 112 to accommodate an aberrantly-sized encapsulated food product 114.

It is generally found desirable to include one or more of a variety of types of viscous food products 116 in association with encapsulated food products 114. Examples of such viscous food products 116 include, for example, cheeses which are capable of softening or melting at elevated temperatures, and stewed meat-based food items, such as commercially-available canned chili. In a preferred embodiment, diced onions and diced cilantro are added to the viscous food product to add flavor. It is further desirable to achieve a relatively uniform distribution of the viscous food product 116 around the encapsulated food product 114 in order to facilitate relatively uniform cooking of the contents of the packaged food item 110, as further explained below. In addition, relative uniformity in distribution of the viscous food product 116 around the encapsulated food product 114 serves to facilitate a relatively constant flavor resulting in any particular cross-sectional sampling of the packaged food item 110, which results from the controlled ratio of encapsulated food product 114 to viscous food product 116.

Close association between the viscous food products 116 and the encapsulated food product 114, as well as relatively even distribution of viscous food product 116 within the assembly 110, may be provided by closely associating the edible wrapper 112 with the encapsulated food product 114 and viscous food product 116. In one embodiment, the encapsulated food product 114 of a known and predetermined size and shape is provided and applied to a surface of the edible wrapper 112. The positioning may be normal to one pair of opposed edges 134, or, in a preferred embodiment, in a direction generally corresponding to a line between two diagonally-opposed corners 136, 138. Viscous food product 116 is applied over the encapsulated food product 114. In a preferred embodiment, the amount of viscous food product 116 distributed is predetermined, which serves to regulate the flavor distribution in the assembly, as well as facilitating predictability in material costs. The viscous food product 116 may also be applied to the edible wrapper 112 prior to application of the encapsulated food product 114, and may further include providing an additional application of viscous food product 116 over the encapsulated food product 114 once it has been provided to the assembly 110. In a preferred embodiment, the predetermined amount of viscous food product 116 will be an amount sufficient to substantially surround the encapsulated food product 114 in the assembly, along the length of the encapsulated food product 114, as shown in, for example, FIG. 2B; however, the precise amount of viscous food product 116 is dependent on the size of the encapsulated food product 114 selected by the manufacturer and the desired size of the final packaged assembly 110.

Following application of the encapsulated food product 114 and distribution of the viscous food product 116 to the edible wrapper 122, the assembly is packaged by folding opposed corners 136, 138 over respective ends of the encapsulated food product 114 along lines generally corresponding to lines 118 and 120. Thereafter, corner 122 is folded over the encapsulated food product 114 and viscous food product in a direction generally corresponding to a line (not shown) between corner 122 and corner 124. The assembly 110 is then rolled in a direction generally corresponding to a line between corner 122 and corner 124 until the assembly 110 is generally cylindrical, with closed ends, with corner 124 resting flush against another region of the surface of the edible wrapper 112.

As best shown in FIG. 2A-B, assembling the packaged food product 110 in the process as described above can serve to suspend the encapsulated food product 114 in the edible wrapper 112 such that the encapsulated food product 114 is substantially surrounded by a relatively even distribution of viscous food product 116. In a preferred embodiment, the distribution of viscous food product 116 about the encapsulated food product 114 is substantially constant as between most cross-sectional samples, as indicated by, for example, lines 202 and 204, which correspond to the representational cross-sections of the assembly 110 depicted in FIG. 2B. In addition, edible wrapper 112 and the encapsulated food product 114 each provide surfaces to be applied against the viscous food product 116 such that, to the extent little or no empty space exists within the area between the edible wrapper 112 and the packaged food product 114 (generally represented as the space within which the viscous food product 116 is disposed in FIG. 2B), migration of the viscous food product 116 within the assembly 110 is inhibited. Such inhibition of the migration of the viscous food product 116 within the assembly 110 further serves to control the flavor ratio between the viscous food product 116 and the encapsulated food product 114 by maintaining the relatively even distribution of the viscous food product about the encapsulated food product 114. Once the assembly 110 is complete, it may be cooked in, for example, a deep fryer; however, one skilled in the art will readily appreciate that numerous cooking methods may be employed depending on the precise materials used and the desired qualities of the finished product. The relatively even distribution of viscous food product 116 about encapsulated food product 114 within the edible wrapper 112 further serves to promote more even temperature distribution within the assembly 110 during cooking, and thus more uniformity in manufacturing the assemblies 110.

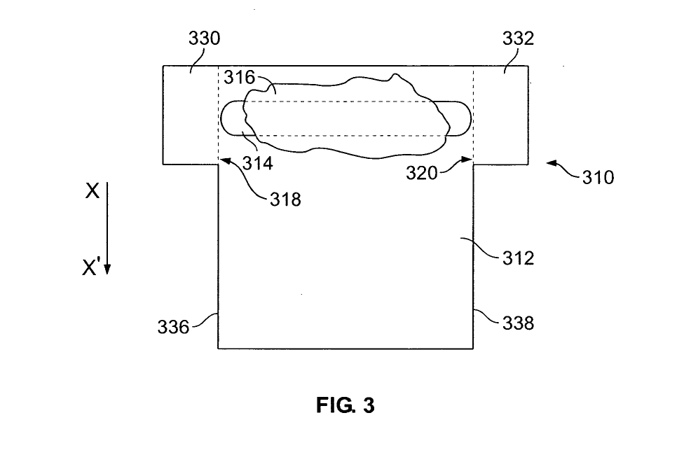

As best shown in FIG. 3, embodiments of the present invention may utilize an edible wrapper 312 having an overall T-shaped border achieved by forming tabs 330, 332 on peripheral edges 336, 338 opposite one another. The edible wrapper 312 is adapted to receive an encapsulated food product 314, preferably of predetermined size, and a metered portion of viscous food product 316 in a region generally located between the tabs 330, 332. The tabs 330, 332 are folded over respective ends of the encapsulated food product 314, and the assembly is rolled in a direction X-X′ in order to enclose the viscous food product within the edible wrapper 312 and substantially surrounding the encapsulated food product 314. The tabs may be formed along any length of the opposed edges 336, 338, and further may be formed opposite one another or offset with respect to one another. The tabs 330, 332 may also be formed of a plurality of straight sides, rounded, or any other shape suitable for folding over ends of the encapsulated food product to form ends of the assembly 110. Use of the edible wrapper 312 having the tabs 330, 332 allows the manufacturer to use less edible wrapper 312 material to manufacture the assembly 310. In addition, such an edible wrapper 312 configuration further allows the assembly 310 to be manufactured having a more constant amount of edible wrapper 312 material through most of the length of the assembly 310, with the exception of the assembly 310 ends (not shown) that have additional edible wrapper 312 material present due to the presence of the tabs 330, 332, as compared to an assembly as shown in FIGS. 1-2 having more wrapper material in the middle cross section (corresponding to cross-sectional line 202) than areas adjacent to the wrapper middle (as shown at, for example, cross-sectional lines 204).

While endeavoring in the foregoing specification to draw attention to those features of the invention believed to be of particular importance it should be understood that the Applicants claim protection in respect of any patentable feature or combination of features hereinbefore referred to and/or shown in the drawings whether or not particular emphasis has been placed thereon. While the apparatus and method herein disclosed forms a preferred embodiment of this invention, this invention is not limited to that specific apparatus and method, and changes can be made therein without departing from the scope of this invention, which is defined in the appended claims.

What is claimed is:

1. A packaged food item, comprising:
an encapsulated food product of predetermined size and shape;
an edible wrapper enveloping the encapsulated food product, the edible wrapper having a predetermined size and shape sufficient to completely surround the encapsulated food product, the edible wrapper having a substantially uniform thickness, the edible wrapper shape being rectilinear, the rectilinear shape including at least one set of opposed peripheral edges, and wherein at least a portion of the edible wrapper is spaced apart from the encapsulated food product to define a space between the edible wrapper and the encapsulated food product; and
a viscous food product disposed within the space, the edible wrapper and the encapsulated food product each providing a surface to associate with the viscous food product whereby the migration of the viscous food product within the space is inhibited.

2. The edible wrapper of claim 1 wherein the rectilinear shape includes a pair of tabs formed on the at least one set of opposed peripheral edges.

3. The packaged food item of claim 1, wherein the encapsulated food product is a meat product packaged within a casing.

4. The packaged food item of claim 1, wherein the encapsulated food product has a longitudinal length;
the space defined by the edible wrapper and the encapsulated food product substantially surrounds the encapsulated food product; and
a predetermined amount of viscous food product is disposed within the space substantially surrounding the encapsulated food product such that the distribution of the viscous food product along the longitudinal length of the encapsulated food product is substantially uniform.

5. The packaged food item of claim 1, wherein the edible wrapper enveloping the encapsulated food product is comprised of a plurality of edible wrappers, each edible wrapper having a predetermined size and shape, the plurality of edible wrappers in combination being sufficient to completely surround the encapsulated food product, the plurality of edible wrappers each having a substantially uniform thickness, the shape of the plurality of edible wrappers being rectilinear, the rectilinear shape of each edible wrapper including at least one set of opposed peripheral edges, and wherein at least a portion of at least one edible wrapper of the plurality of edible wrappers is spaced apart from the encapsulated food product to define a space between the edible wrapper and the encapsulated food product.

6. The packaged food item of claim 5, wherein the encapsulated food product has a longitudinal length;
a portion of each of the plurality of edible wrappers is spaced apart from the edible food product to define at least one space between the plurality of edible wrappers and the encapsulated food product, the at least one space substantially surrounding the encapsulated food product; and
a predetermined amount of viscous food product is disposed within the at least one space such that the distribution of the viscous food product along the longitudinal length of the encapsulated food product is substantially uniform.

7. A packaged food item, comprising:
an encapsulated food product, the encapsulated food product consisting essentially of a meat product packaged within a casing, the encapsulated food product having a first end and an opposed second end;
an edible wrapper enveloping the encapsulated food product, the edible wrapper having a predetermined size and shape sufficient to completely surround the encapsulated food product, the edible wrapper shape being rectilinear, the rectilinear shape including at least one set of opposed peripheral edges; and
a first tab and a second tab formed on the at least one set of opposed peripheral edges, the first tab being positioned proximate the first end of the encapsulated meat product, the second tab being positioned proximate the second end of the encapsulated meat product, the first tab and the second tab being adapted to be positioned over the first end and the second end of the encapsulated food product whereby the first tab forms a first end of the packaged food item and the second tab forms the second end of the packaged food item.

8. The packaged food item of claim 7, wherein at least a portion of the edible wrapper is spaced apart from the encapsulated food product to define a space between the edible wrapper and the encapsulated food product.

9. The packaged food item of claim 8, further comprising a viscous food product disposed within the space, the edible wrapper and the encapsulated food product each providing a surface to associate with the viscous food product whereby the migration of the viscous food product within the space is inhibited.

10. The packaged food item of claim 9 wherein the viscous food product disposed within the space is a predetermined amount of viscous food product.

11. A method of manufacturing a packaged food item, comprising:
providing a sheet of edible material having a predetermined size and shape, the sheet of edible material including a first surface and a second surface, the first surface and second surface being substantially planar, the sheet of edible material having a substantially uniform thickness and a rectilinear border, the rectilinear border including opposed regions, the sheet of edible material being adapted to surround and envelop a food item emplaced proximate the first surface;
providing an encapsulated food product proximate the first surface of the edible material, the encapsulated food product consisting essentially of a meat product packaged within a casing, the encapsulated food product having a predetermined size;
distributing a predetermined amount of viscous food product over at least a portion of the packaged food product; and
enveloping the encapsulated food product and the viscous food product with the sheet of edible material such that the packaged food item and the viscous food product are completely surrounded by the sheet of edible material, the sheet of edible material and encapsulated food product each providing a surface to associate with the viscous food product whereby the edible wrapper and the encapsulated food product inhibit the migration of the viscous relative to the edible wrapper and the encapsulated food product.
